(19) United States
(12) Patent Application Publication
(10) Pub. No.: US 2013/0175778 A1
(43) Pub. Date: Jul. 11, 2013

(54) METHOD FOR MANUFACTURING A PART MADE OF STRESS-RESISTANT COMPOSITE MATERIAL

(71) Applicant: Guíllaume Pílastre, Amiens (FR)

(72) Inventor: Guíllaume Pílastre, Amiens (FR)

(73) Assignee: COPARL, Ailly-Sur-Noye (FR)

(21) Appl. No.: 13/809,856

(22) PCT Filed: May 18, 2011
(86) PCT No.: PCT/FR2011/051113

§ 371 Date: Mar. 28, 2013

(30) Foreign Application Priority Data
Jul. 20, 2010 (FR) 1055915

(51) Int. Cl. B29C 45/00

(52) U.S. Cl. CPC B29C 45/0005
USPC 280/124.1; 264/328.12

(57) ABSTRACT

A method for manufacturing a stress-resistant part made of a composite material, wherein the composite material is forced to flow in a channel belonging to a mold and delimited by a selectively heated wall, the fibers of the composite material assuming a statistically preferential orientation by means of the flow.

The composite material comprises a thermosetting resin, the flow of this material in the channel and the heating of the wall of the channel are concomitant, and the temperature of the channel and the flow velocity of the composite material in the channel are determined with respect to each other so that the composite material flowing in this channel forms a fluid line, the mean cross-section of which decreases during the flow of this material in said channel due to the polymerization of the resin.

### PRIORITY CLAIM

The present application is a National Phase entry of PCT Application No. PCT/FR2011/051113, filed May 18, 2011, which claims priority from French Application No. 1055915, filed Jul. 20, 2010, the disclosures of which are hereby incorporated by reference herein in their entirety.

### FIELD OF THE INVENTION

The invention generally relates to molding techniques.

More specifically, according to an embodiment, the invention relates to a method for manufacturing a stress-resistant part made of a composite material comprising at least a resin and reinforcing fibers laid in resin, this method comprising at least a molding operation by compression, by transfer, or by injection, wherein the composite material is forced to flow in a channel belonging to a mold and delimited by a wall that can be heated, and wherein the fibers assume an at least statistically preferential orientation by means of the flow of the composite material.

### BACKGROUND

A method of molding is, for example, described in patent GB 2 015 414.

However, this known method does not make it possible to manufacture only parts in composite material using a thermoplastic resin and wherein the preferential orientation of the fibers results only from a prior orientation of the fibers during the introduction of the composite material into the mold.

### SUMMARY OF THE INVENTION

The present invention produces parts with higher resistance, and particularly parts subjected to mechanical constraints such that they were only produced in metal up until now.

The resin is a thermosetting resin, in that the flow of the composite material in the channel and the heating of the wall of this channel are at least partially concomitant, and the temperature of the channel and the flow velocity of the composite material in the channel are determined with respect to each other so that the composite material flowing in this channel forms a fluid line, the mean cross-section of which decreases during the flow of this material in said channel due to the polymerization of the resin.

A part according to an embodiment is produced in a composite material including at least a resin and reinforcing fibers laid in the resin, and which comprises at least a stress-resistant area delimited by an outer surface and having an extended shape in a first direction, wherein the resin is thermosetting and in that the reinforcing fibers, in said stress-resistant area, are mainly oriented in a same direction.

The said same direction of the fibers is, at least over the largest portion of the length of these fibers, intermediary between said first direction and a direction perpendicular to the outer surface and, in an embodiment, nearer the first direction than the direction perpendicular to the outer surface.

In an embodiment of such a part, said stress-resistant area may be at least partially tubular.

The method of the invention may be applied to the production of a suspension strut for an automotive vehicle.

### BRIEF DESCRIPTION OF THE DRAWINGS

Other characteristics and advantages of the invention will become more apparent from the reading of the following description, for reference only, and in no way limiting, in reference to the accompanying drawings.

FIG. 1 is a schematic view of a mold to be used to implement the method of the invention and represented in open configuration.

FIG. 2 is a schematic view of a mold to be used to implement the method of the invention and represented at the start of closing.

FIG. 3 is a schematic view of a mold to be used to implement the method of the invention and represented in active molding configuration.

FIG. 4 is a schematic view of a mold to be used to implement the method of the invention and represented at the end of molding.

FIG. 5 is a schematic view of a first alternative of the mold such as illustrated in FIG. 3, the mold according to this alternative being also represented in active molding configuration.

FIG. 6 is a schematic view of the first alternative of the mold such as illustrated in FIG. 4, the mold according to this alternative being also represented at the end of molding.

FIG. 7 is a schematic view of a second alternative of the mold such as illustrated in FIG. 3, the mold according to this second alternative being also represented in active molding configuration.

FIG. 8 is a schematic view of the first alternative of the mold such as illustrated in FIG. 4, the mold according to this second alternative being also represented at the end of molding.

### DETAILED DESCRIPTION

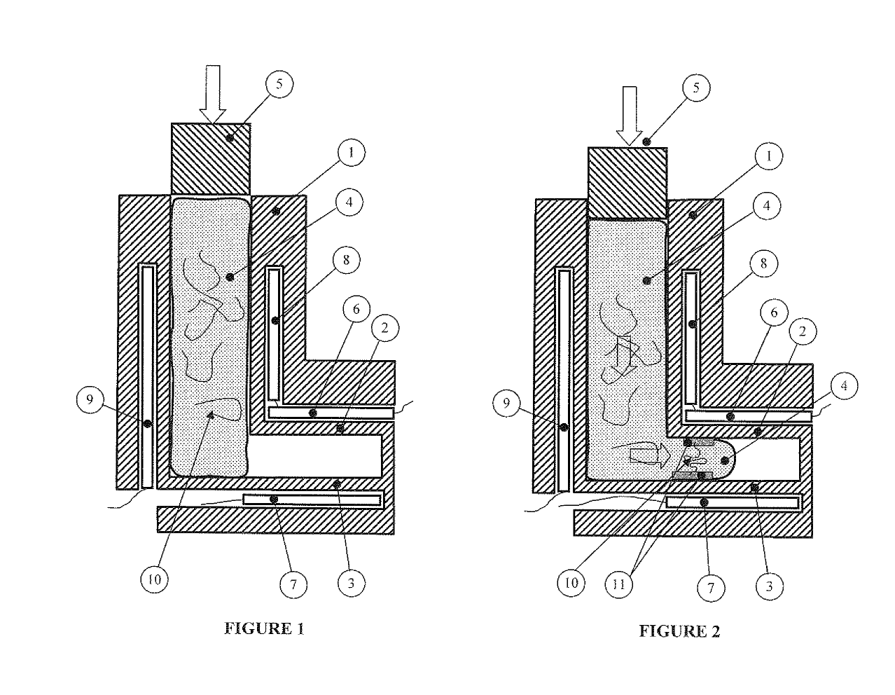

What is described is a method which makes it possible to achieve, by a compression molding, a transfer molding or by an injection molding operation, a part in stress-resistant composite material, FIGS. 1-8 illustrating a compression molding method.

The composite materials, which may be in the form of sheets, stacking of sheets or a paste, comprise at least two components, namely, a matrix 4 including at least a resin, and a reinforcement comprised of fibers 10, i.e., of members whereof a dimension is much greater than the rest.

The reinforcement 10 plays the role of a skeleton supporting the mechanical efforts, as for the matrix 4 its function is to transmit the mechanical efforts to the reinforcement 10 and to ensure the cohesion of the material.

The matrix 4 can comprise a thermosetting resin (polyester, vinylester, epoxy or others) which sets by polymerization under the effect of a rise in temperature, and possibly the loading material which makes it possible to reduce the costs and modify the physical characteristics of the material.

The reinforcement 10 may be constituted of fibers (glass, carbon, “Kevlar”, aramids and others) whereof the length is advantageously higher than or equal to the thickness of the wall constituting the stress-resistant area of the part to be produced, and be present in a proportion ranging between 10% and 60% of the mass of the material constituting this part.

The currently known molding methods by compression operate in two distinct phases where the first phase consists in filling and closing the mold, and the second phase consists in causing the polymerization of the resin, hence, the solidification of the matrix, and opening the mold.

In the thus, produced known parts, the reinforcing fibers have a random orientation, such that these parts offer a mechanical resistance that is at the same time isotropic and relatively low.

According to an embodiment of the invention, one purpose is to make at least partially concomitant the two traditional molding phases and particularly to start the polymerization of the thermosetting resin 4 before the end of the closing of the mold or at the end of the injection in the case of a molding by injection, such as to obtain a privileged orientation of the fibers 10 at least in a determined area of the part, and to thus reinforce the resistance of this part in this area.

To this end, one purpose of the invention is to adjust one with respect to the other the temperature of the mold at least in the channel of the mold 1 which must form the resistant area of the part, and the flow velocity of the composite material in this channel, such as to obtain a polymerization of the resin present in the matrix 4 near the walls 2 and 3 of the channel, while the composite material continues to flow in the core of the fluid line which it forms in the channel.

The portions of the fibers 10 which are included in the already polymerized areas are thus blocked, whereas the portions of the fibers 10 which are included in the still un-polymerized areas move in the direction of the flow of the composite material.

As a result, these fibers 10 are mainly oriented, and almost practically without exception, in a same direction, as depicted, for example, in FIG. 4.

The common privileged direction of the fibers 10 is at least on the largest portion of the length of these fibers, the nearest possible to the direction taken by the flow of the composite material during the closing of the mold 1, this privileged orientation of the fibers 10 making it possible to increase the mechanical resistance of the part produced with respect to the mechanical stress to which this part may be subjected and which translates by an urging of the fibers in their preferential orientation.

Although the flow velocity of the composite material in the channel or each channel of a mold depends on several factors such as the shape, length and thickness of the channel, the viscosity of the material, the velocity of the closing of the mold and the molding pressure, a person skilled in the art knows how to assess this velocity.

A person skilled in the art further knows the law that relates the polymerization velocity of the composite material to the temperature of this material, and to adjust one with respect to the other the flow velocity of the material in the channel and the temperature in this channel such that, on the one hand the polymerization starts before the end of the flow of the composite material in the mold and such that on the other hand, the composite material may flow in order to fill the entire mold before the end of the polymerization.

In a manner known per se, the walls such as 2 and 3 of each channel are heated by means of heating members such as 6, 7, 8 or 9.

In an embodiment of the invention, the composite material, which comprises at least fibers 10 and a matrix 4 including a thermosetting resin, is inserted in a mold 1 whereof at least a channel is delimited by one or several walls 2 and 3 heated by heating members 6, 7, 8 or 9.

The composite material is then mechanically compressed by means of a member 5 which closes the mold.

This compression generates the flow of the composite material, which forms a fluid line making it possible, at the end of molding, to entirely fill the mold with composite material.

The embodiments as disclosed herein are applicable for the production of parts exhibiting, in their resistance area, a thickness ranging between 3 mm and 30 mm.

As FIG. 2 shows, the flow of composite material in the channel and the polymerization of the resin contained in this material constitute two phenomena which, according to an embodiment of the invention, conflict with one another, such that the fluid line, formed by the composite material progressing in the channel of the mold exhibits a transversal cross-section which is reduced due to the resin 4 polymerization on the walls 2 and 3 of the channel.

Although a person skilled in the art is able to implement the invention directly based on the above indications and his general knowledge, another embodiment of the invention may be obtained based on a number of trials and the following indications.

The influencing parameters of the embodiment are constituted by the closing time Tf of the mold 1, the temperature Tp of the walls 2, 3 of the channel wherein the resistance area of the part is molded, the pressure P of the molding, the start time Td of the polymerization of the thermosetting resin, known as the exothermicity start time, and the viscosity N of the composite material.

The start time Td of the polymerization represents the minimum period during which the material should be in contact with the heated wall of the mold in order to initiate the polymerization process. This time Td is specific to each material and varies according to the temperature Tp of the walls: the higher the temperature Tp is, the shorter the time Td is and, conversely, the lower temperature Tp is, the longer the time Td is.

Consequently, the closing time Tf of the mold should be adapted such that it is higher than the start time Td of the polymerization to make the orientation of the fibers possible in the direction of the flow.

The greater the difference between times Tf and Td, the more important the quantity of fibers directed in the flow direction, and the higher the mechanical stress of the produced part will be for forces where the resulting mechanical stresses urge the composite material in the preferential orientation direction of the fibers.

As the complete filling of the mold 1 needs to be ensured, the molding pressure P must be adjusted according to the viscosity N of the composite material in order to attain this result, the molding pressure P needing to be all the more significant the more viscous N it is.

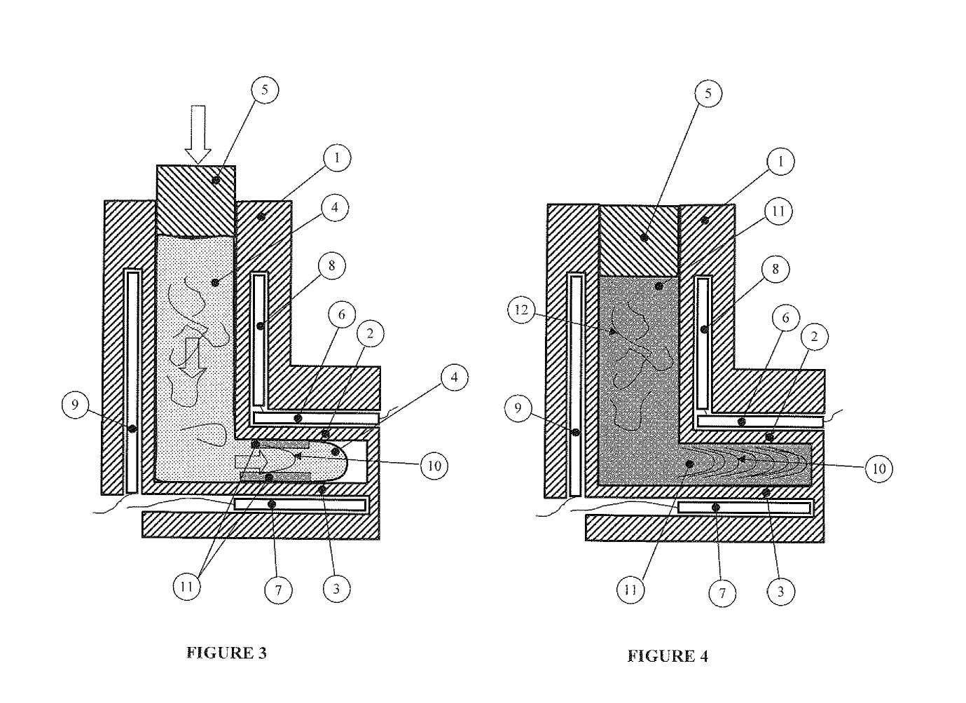

FIG. 3 illustrates the drive, by the fluid line of the not-yet solidified composite material, and in the flow direction of this fluid line, of the portion of fibers 10 not-yet blocked by the already-polymerized resin 11. This phenomenon, which makes the tensing of the fibers 10 and their orientation in the flow direction of the fluid line possible, gives the molded part optimal resistance in this area.

This fiber orientation method may be applied to the whole molded part, or applied solely to one or several specific areas of this part. This differentiation is obtained by applying a lower temperature in the areas where the fiber preferential orientation is not sought for. The difference in temperature between the areas of the mold where a privileged orientation of the fibers is sought and the areas where such an orientation is not sought is obtained by different adjustments of the heating members in each area, the temperature of the heating members 8 and 9 being for example lower than that of the heating members 6 and 7.

FIG. 4 illustrates the state in which the mold is entirely closed and in which the solidification of the composite material has ended, thus making it possible to set the fiber 10 orientation for good.

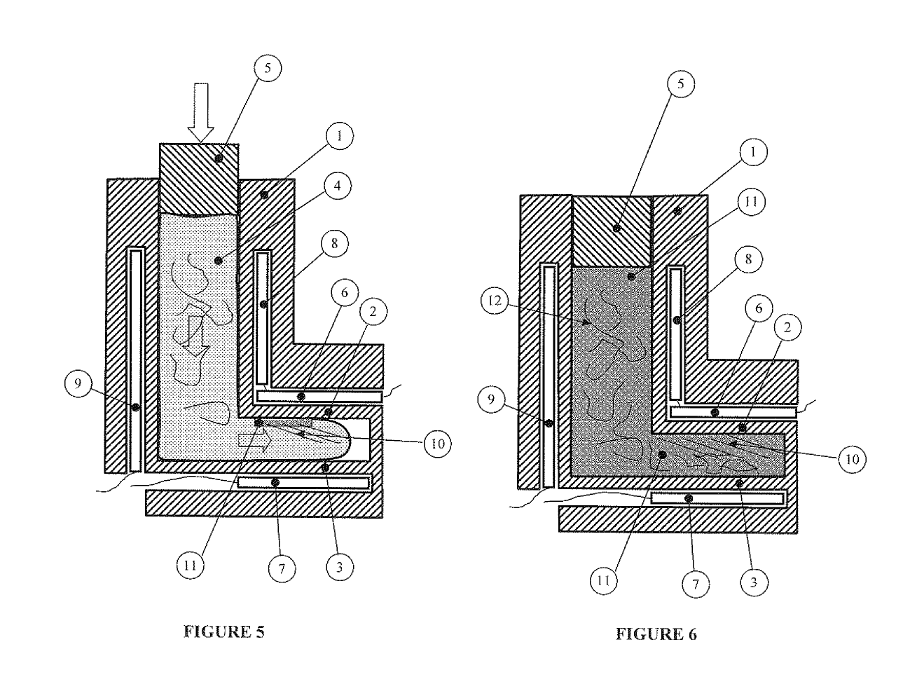

FIGS. 5 and 6 illustrate an orientation mode of the fibers 10 wherein the heating members of one channel are put at different temperatures.

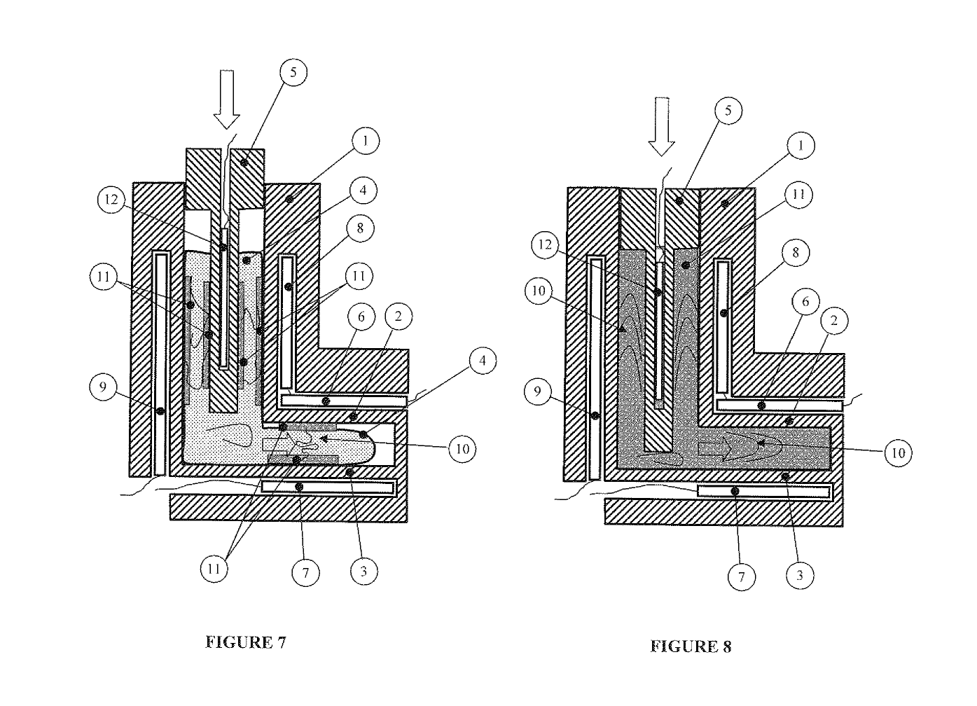

FIGS. 7 and 8 illustrate an application of the method of the invention upon producing a hollow part.

The embodiments as described herein make it possible to achieve parts in composite material having a particularly higher mechanical resistance, for example twice as high as that of the produced parts from the same composite material, by using the conventional compression molding, compression transfer molding and injection methods.

1. A method for manufacturing a stress-resistant part made of a composite material comprising at least a resin and reinforcing fibers laid in resin, the method comprising at least a molding operation selected from the group consisting of by compression, by transfer compression, and by injection, wherein the composite material is forced to flow in a channel belonging to a mold and delimited by at least one wall liable to be heated, and wherein the fibers assume an at least statistically preferential orientation by means of the flow of the composite material, wherein the resin is a thermosetting resin, in that the flow of the composite material in the channel and the heating of the wall of the channel are at least partially concomitant, and in that the temperature of the channel and the flow velocity of the composite material in the channel are determined with respect to each other so that the composite material flowing in the channel forms a fluid line, the mean cross-section of which decreases during the flow of the material in said channel due to the polymerization of the resin.

2. A method of producing a part in a composite material comprising at least a resin and reinforcing fibers laid in resin, the part comprising at least a stress-resistant area delimited by an outer surface and having an extended shape in a first direction, wherein the resin is thermosetting and in that the reinforcing fibers, in said stress-resistant area, are mainly oriented along a same direction.

3. The method according to claim 2, wherein said same direction of fibers is, at least on the largest portion of the length of the fibers, intermediary between said first direction and a direction that is perpendicular to the outer surface.

4. The method according to claim 3, wherein said same direction of the fibers, is, at least on the largest portion of the length of the fibers, nearer to said first direction than the direction perpendicular to the outer surface.

5. The method according to claim 2, wherein said stress-resistant area is at least partially tubular.

6. A suspension strut for an automotive vehicle made according to the method of claim 1.
